(19) United States
(12) Patent Application Publication
(10) Pub. No.: US 2007/0140928 A1
(43) Pub. Date: Jun. 21, 2007

(54) Low pressure drop coated diesel exhaust filter

(76) Inventors: Douglas Munroe Beall, Painted Post, NY (US); Achim Karl-Erich Heibel, Corning, NY (US); Tinghong Tao, Big Flats, NY (US)

Correspondence Address: CORNING INCORPORATED, SP-TI-3-1, CORNING, NY, 14831, US

(21) Appl. No.: 11/638,899

(22) Filed: Dec. 14, 2006

Related U.S. Application Data
(60) Provisional application No. 60/751,062, filed on Dec. 16, 2005.

(51) Int. Cl. B01D 50/00

(52) U.S. Cl. 422/177

(57) ABSTRACT

A coated diesel exhaust filter is provided that applies a relatively low pressure drop across the exhaust system despite the buildup of soot deposits. The filter includes a porous ceramic structure having an inlet end, an outlet end, and a plurality of gas inlet and gas outlet channels disposed between the inlet and outlet ends, the channels being separated by porous ceramic walls. A catalyst is distributed at least partly within the porous ceramic walls of the structure, and is distributed at a higher concentration within portions of the ceramic walls adjacent to the outlet surfaces than within portions of the ceramic walls adjacent the inlet surfaces. Both the inlet and outlet surfaces are substantially free of the catalyst in order to maintain a gas-conducting porosity in these surfaces. The resulting filter effectively treats nitrogen oxides, carbon monoxide and unburned hydrocarbons present in the exhaust gas stream while advantageously imposing a relatively low pressure drop across the exhaust system even when soot deposits accumulate on the inlet surfaces of the ceramic walls.

This application claims the benefit of U.S. Provisional No. 60/751,062, filed Dec. 16, 2005, entitled “Low Pressure Drop Coated Diesel Exhaust Filter.”

### FIELD OF THE INVENTION

The present invention is in the field of combustion engine exhaust emissions control and particularly relates to ceramic wall flow filters used to trap particulates such as soot that are normally present in the exhaust streams of diesel engines.

### BACKGROUND OF THE INVENTION

Catalyst-coated diesel exhaust filters are well-known in the prior art. Such filters generally comprise a honeycomb structure of a porous ceramic material, such as silicon carbide (SiC). Such filters have an inlet end for receiving diesel exhaust gas, an outlet end, and a plurality of gas inlet and gas outlet channels disposed between the inlet and outlet ends which are separated by porous ceramic walls. Exhaust gases conducted through the inlet end of the honeycomb structure must pass through the porous ceramic walls before they are discharged into the ambient atmosphere.

In such filters, the pore size is sufficiently small to filter out particulate contaminates, which ultimately accumulate in the form of soot on the inlet surfaces of the ceramic walls separating the gas inlet and gas outlet channels. Additionally, the ceramic walls of such are coated with one or a combination of exhaust treatment catalysts, including diesel oxidation catalysts that can assist in the combustion of unburned hydrocarbons, carbon monoxides and carbon particulates and nitrogen reduction catalysts that can reduce harmful nitrogen oxides present in diesel exhaust to nitrogen or harmless oxides. Such catalytic coatings are formed from particles such as platinum, palladium or rare earth metals which promote hydrocarbon oxidation or the conversion of higher nitrogen oxides to nitrogen or N2O.

The coating of catalytic material generally resides on the inlet surfaces of the walls in prior art filters in order to promote rapid oxidation or nitrogen oxide conversion. The coating is applied to the ceramic structure by filling the inlet channels with a liquid suspension of the particles of catalyst while a vacuum is applied to the outlet channels of the structure. Hence, particles of the catalyst are distributed not only on the surface of the porous ceramic walls, but into the ceramic microstructure adjacent to the inlet surface.- Such a vacuum-draw coating processes are used to distribute the particles of catalyst over a volume of the inlet portion of the walls, as opposed to solely the inlet wall surface, which would tend to fill the pores on the inlet surfaces to such an extent that the wall becomes highly resistance to gas flow.

While such prior art coated diesel exhaust filters are reasonably effective in achieving their purposes, the inventors have observed that the pressure drop they apply to the exhaust system becomes disadvantageously large after soot deposits begin to accumulate in the inlet surfaces of the ceramic walls. The applicants believe that this undesirably large pressure drop is caused by a partial obstruction of the micro-structure of the ceramic walls from the particles of catalysts that are deposited therein as a result of the coating process, which in turn promotes a more complete obstruction as soot begins to fill the unobstructed pores.

Clearly, there is a need for an improved coated diesel exhaust filter that is capable of effectively removing particulate contaminates as well as nitrogen oxides and/or incompleted oxidized carbon species without the imposition of an undesirably large pressure drop with the buildup of carbonaceous soot deposits on the inlet surfaces of the ceramic walls. Ideally, the fabrication of such an improved exhaust filter would not require a radical change or re-tooling of manufacturing facilities, and would be relatively easy to manufacture from the same materials presently used in such diesel exhaust filters.

### SUMMARY OF THE INVENTION

Generally speaking, the invention is a catalyst-coated diesel exhaust filter that overcomes the aforementioned shortcoming associated with the prior art. To this end, the diesel exhaust filter of the invention comprises a porous ceramic structure having a plurality of gas inlet and gas outlet channels separated by porous ceramic walls having inlet surfaces forming gas inlet channels and outlet surfaces forming gas outlet channels, and a catalyst in the form of a coating or deposit that is distributed at least partly within the porous ceramic walls of the structure, wherein the catalyst is distributed at a higher concentration within portions of the ceramic walls adjacent the outlet surfaces than within portions of the ceramic walls adjacent to the inlet surfaces.

In a specific embodiment, at least 60% of the catalyst is distributed from a mid-point of the thickness of the walls to the outlet surfaces of the walls. The inlet surfaces of the ceramic walls are substantially free of the catalyst to prevent the catalyst from obstructing the flow of exhaust gases through the walls. However, a sufficient amount of catalyst is distributed between a mid-point in the thickness of the walls and the outlet channel surfaces to promote nitrogen oxide reduction and/or carbon compound (carbon monoxide, hydrocarbon) oxidation. Finally, embodiments wherein the increase in concentration of the catalyst is substantially non-linear along the thickness of the ceramic wall, and/or wherein the outlet wall surfaces of the filter structure remain substantially free of bulk catalyst coating, are provided. The absence of catalysts deposited on the surfaces of the porous channel walls of the structure is helpful to reduce or avoid the obstruction of exhaust gas flow through the walls.

The coated diesel exhaust filter of the invention provides a filter that is capable of reducing nitrogen oxide and unburned carbon compound emissions while filtering soot from the engine exhaust gases, and maintains a relatively low pressure drop even when soot accumulates on the inlet surfaces of the ceramic walls. It is also relatively easy and simple to manufacture from conventional materials.

### DESCRIPTION OF THE DRAWINGS

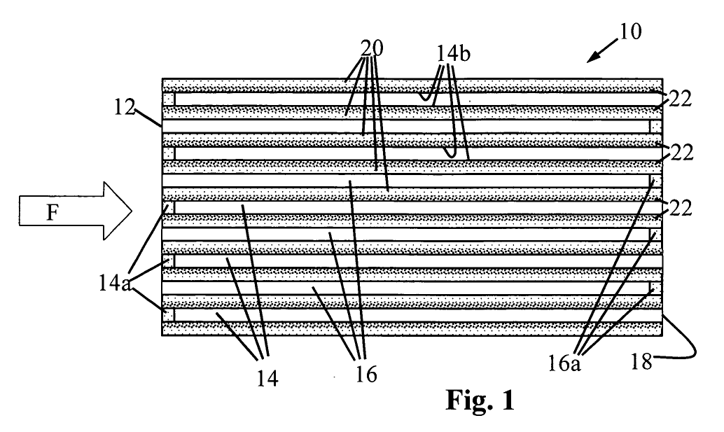

The invention is further described below with reference to the appended drawing, wherein FIG. 1 presents a schematic illustration, in cross-sectional elevational view but not in true proportion or to scale, of a catalyzed engine exhaust filter provided in accordance therewith.

### DETAILED DESCRIPTION OF THE PREFERRED EMBODIMENT

The invention is not limited in its application to the use of any particular porous ceramic material for the construction of the filter. A number of different porous ceramics have been proposed for such use, particular examples of suitable materials including cordierite, silicon carbide, silicon nitride, aluminum titanate, eucryptite, calcium aluminate, zirconium phosphate, and spodumene. All of these materials can exhibit refractoriness and thermal expansion coefficients within the ranges known to be required for adequate thermal durability in engine exhaust systems, and all can function effectively to remove particulates present in an exhaust stream with greater or lesser efficiency depending upon the pore sizes and pore size distributions provided in the ceramic walls through particulate-laden exhaust gases are to flow.

Porosity values for ceramic wall flow filter bodies generally are in the range of about 35-85% by volume, although somewhat narrower pore size ranges of from 40-70% are helpful to enhance particulate removal efficiency while still avoid undue exhaust flow restrictions. Average pore sizes in these materials can range from as low as 5 micrometers to as high as 25 micrometers, but again balancing exhaust filter back pressures against efficient particulate trapping may dictate a narrower filter average pore size in the range of 10-15 micrometers.

The catalyst selected for deposit into the outlet channel walls of the filter will depend mainly on the compositions and concentrations of undesirable exhaust gas constituents to be treated. Catalysts of known utility for use in catalyst coatings for the treatment of exhaust gas emissions include Ru, Rh, Pt, Pd, Ir, Ni, Cu, V, W, Y, Ce, Ti, and Zr, oxides of these metals, and combinations of these metals and oxides. Of particular utility for the oxidation of pollutants present in diesel engine exhaust gases are the transition metals such as Ni, Cu, V and W and their oxides, as well as the catalytically active precious metals Pt, Pd and Rh.

Emissions control catalysts of the above compositions are generally not deposited directly on or within the porous ceramic substrates used to support them, but rather are deposited on washcoats of oxide composition, optionally including other chemical compounds as catalyst promoters, that operate to improve catalyst stability and functionality. Examples of washcoating oxides that are particularly useful in catalyst coatings for the treatment of diesel engine exhaust gases include alumina, rare-earth oxides, ceria, and zirconia. Included in the washcoats along with these oxides in some cases are promoters such as barium oxide and the transition metal oxides.

A schematic illustration in elevational cross-section of a catalyzed porous ceramic exhaust gas filter produced in general accordance with the invention is presented in FIG. 1 of the drawing. A porous ceramic wall flow exhaust gas filter 10 designed to filter an exhaust gas flowing in the direction of flow arrow F comprises an inlet end 12 at which a collection of outlet channels such as channels 14 are alternately plugged by means of plugs 14a. The remaining collection of inlet channels such as channels 16 are plugged at the filter outlet end 18 by means of plugs 16a.

Deposited within porous channel walls 20 of the filter and preferentially located toward the surfaces 14b of outlet channels 14 is a catalyzed washcoating deposit 22 consisting, for example, of a high surface area alumina coating material supporting an active platinum metal catalyst. In the embodiment shown, little or no catalyzed washcoating is disposed as surface layer material on the surfaces 14b of the outlet channels, nor as any of the catalyst coating disposed near or on the channel walls bounding the inlet channels of the structure.

A prophetic example of the manufacture of a ceramic filter incorporating a catalyst coating disposed within the outlet channel walls of the structure in the manner suggested by FIG. 1 is provided below.

### EXAMPLE

Several ceramic honeycomb catalyst substrate samples are blown out with high pressure air to remove dust prior to processing. The samples selected are of aluminum titanate composition with principal crystal phases of aluminum titanate and alkaline earth feldspar. The honeycombs have a channel density of about 46 cells/cm², a channel wall thickness of about 0.3 mm, and a wall porosity of about 50% by volume with high gas permeability. The honeycombs have an average linear coefficient of thermal expansion (CTE) of approximately 8×10⁻⁷/° C. as measured at a temperature of about 1000° C.

Opposing ends of these honeycombs are selectively plugged to form a wall flow filter body with inlet channels plugged at the filter outlet end and outlet channels plugged at the filter inlet end. Half of the channels are plugged in an alternating checkerboard pattern at the inlet end of the honeycomb to form the filter outlet channels, and the remaining channels are plugged at the opposite or outlet end of the honeycomb in an alternating checkerboard pattern to form filter inlet channels. A plugging paste consisting of a mixture of 13.9% aluminum titanate powder, 13.9% calcium aluminate powder, 6.94% Kaowool® aluminosilicates fibers, 9.77% of a silica sol, 1.39% of a methyl cellulose binder, and 54.1% water by weight is used to accomplish the plugging, with the resulting plugs being cured by heating to 110° C.

To deposit a catalyst in the walls of these plugged filter bodies that is preferentially disposed within the channel walls and toward the outlet side of the filters, an alumina washcoating is selectively applied to channel surfaces within the outlet channels only of the filter. The outlet channels of the structure are briefly filled with a colloidal alumina washcoating solution, commercially available as Nyacol™ AL-20 solution from Nyacol Corporation, Ashland, Mass., USA, and a slight vacuum is applied to the inlet end of the filter to cause the washcoating solution to partially penetrate the outlet channel walls of the filter. The vacuum is then released and excess washcoating solution is removed from the outlet channels and outlet channel surfaces by blowing with high pressure air, so that little or no washcoating solution is present on the surfaces of the outlet channels of the honeycombs.

To selectively apply a catalyst to the distributed washcoating thus provided a catalyst preparation is first prepared by dissolving H₂PtCl₆ in 80 ml water to form an aqueous solution containing about 0.4% platinum by weight. This catalyst solution is then introduced dropwise into the outlet channels of the selectively washcoated honeycombs produced as above described so that the washcoat disposed near the porous surfaces of the outlet channels is wetted by the catalyst solution, but little or no catalyst solution traverses the channel walls to wet the surfaces of the inlet channels. Thereafter, the thus catalyzed honeycombs are dried by heating to 400° C. in air to set the catalyst.

The desired product of a procedure such as described in the foregoing example is a filter product such as schematically illustrated in FIG. 1 of the drawing. Thus the catalyst coating within the porous ceramic walls of the filter are disposed predominantly toward the wall regions proximate to the surfaces of the outlet channels, with little or no catalyst on or proximate to the surfaces of the inlet channels.

Variations in the procedures utilized in the above example can modify the distribution of the catalyst within the porous ceramic walls of the honeycomb, enabling the percentage of catalyst present in to be controlled so that most (60-75%) or all of the catalyst is deposited within the half-thickness of the channel walls forming the surfaces of the outlet channels of the filter. Further, linear and non-linear gradients in catalyst concentration increasing from the inlet channel surfaces toward the outlet channel surfaces can be achieved, for example, by controlling the distribution of the washcoat material within the porous channels walls of the honeycombs during the washcoat deposition step. The foregoing examples and descriptions are therefore merely illustrative of the specific procedures and modifications that may be employed in the production of catalyzed diesel exhaust filters in accordance with the invention as hereinabove described.

What is claimed is:

1. A combustion engine exhaust gas filter comprising:
(i) a porous ceramic structure having an inlet end, an outlet end, and a plurality of gas inlet and gas outlet channels disposed between the inlet end and the outlet end, the channels being separated by porous ceramic walls having inlet surfaces forming the gas inlet channels and outlet surfaces forming the gas outlet channels, and
(ii) a catalyst distributed at least partly within the porous ceramic walls of the structure;
wherein the catalyst is distributed at a higher concentration within portions of the ceramic walls adjacent the outlet surfaces than within the portions of the ceramic walls adjacent the inlet surfaces.

2. A combustion engine exhaust gas filter according to claim 1, wherein at least 60% of the catalyst is distributed in a second half of a thickness of said ceramic walls that terminates at said outlet surfaces.

3. A combustion engine exhaust gas filter according to claim 1, wherein the inlet surfaces of said ceramic walls are substantially free of said catalyst.

4. A combustion engine exhaust gas filter according to claim 1, wherein the catalyst is distributed at an increasing concentration along the thickness of the ceramic walls from their inlet surfaces to their outlet surfaces.

5. A combustion engine exhaust gas filter according to claim 4, wherein said increase in concentration is substantially non-linear along said thickness of the ceramic wall.

6. A combustion engine exhaust gas filter according to claim 2, wherein a first half of a thickness of said ceramic walls includes a sufficient amount of catalyst to promote nitrogen oxide reduction or carbon compound oxidation.

7. A combustion engine exhaust gas filter according to claim 6, wherein at least 75% of the catalyst is distributed in said second half of said thickness of said ceramic walls.

8. A combustion engine exhaust gas filter according to claim 7, wherein said distribution is non-linear along said thickness of said ceramic walls.

9. A combustion engine exhaust gas filter according to claim 1, wherein said exhaust gas filter is a diesel engine exhaust filter, and said catalyst is a diesel oxidation catalyst.

10. A combustion engine exhaust gas filter according to claim 1, wherein said porous ceramic structure is a porous ceramic honeycomb structure.

11. A combustion engine exhaust gas filter comprising:
(i) a porous ceramic structure having an inlet end, an outlet end, and a plurality of gas inlet and gas outlet channels disposed between the inlet end and the outlet end, the channels being separated by porous ceramic walls having inlet surfaces forming the gas inlet channels and outlet surfaces forming the gas outlet channels, and
(ii) a catalyst distributed at least partly within the porous ceramic walls of the structure;
wherein said inlet walls are substantially free of said catalyst, and
wherein a majority of the catalyst is distributed between said outlet surfaces and a midpoint of a thickness of said walls, but sufficient catalyst is present between said inlet surfaces and said midpoint of said thickness to promote nitrogen oxide and carbon compound conversion.

12. The combustion engine exhaust gas filter according to claim 11, wherein said porous ceramic structure is a honeycomb structure.

13. The combustion engine exhaust gas filter according to claim 11, wherein at least 60% of said catalyst is distributed between said midpoint of said walls and outlet wall surfaces.

14. The combustion engine exhaust gas filter according to claim 11, wherein said catalyst is formed from particles having an average size smaller than an average size of pores in said porous ceramic structure.

15. The combustion engine exhaust gas filter according to claim 11, wherein said catalyst is distributed uniformly with respect to a length of said ceramic walls.

16. The combustion engine exhaust gas filter according to claim 11, wherein said catalyst is distributed at an increasing concentration along a thickness of the ceramic walls from their inlet walls to their outlet walls.

17. The combustion engine exhaust gas filter according to claim 16, wherein increase in concentration is generally non-linear along said thickness.

18. The combustion engine exhaust gas filter according to claim 11, wherein said outlet wall surfaces are substantially free of said catalyst.
